(19) United States
(12) Patent Application Publication
(10) Pub. No.: US 2013/0088054 A1
(43) Pub. Date: Apr. 11, 2013

(54) Vehicle Seat Cover

(71) Applicant: Ian Atchison, Temple, TX (US)

(72) Inventor: Ian Atchison, Temple, TX (US)

(21) Appl. No.: 13/646,155

(22) Filed: Oct. 5, 2012

Related U.S. Application Data
(60) Provisional application No. 61/543,489, filed on Oct. 5, 2011.

(51) Int. Cl. B60N 2/60

(52) U.S. Cl. 297/188.01; 297/219.1; 297/228.11

(57) ABSTRACT

A vehicle seat cover generally conforming to the shape of a vehicle seat cushion and configured to be easily attachable thereto. In preferred embodiments the seat cover comprises chenille microfiber and is configured to function as a storage container and/or a vehicle cleaning device when not in use as a seat cover.

### PRIORITY

This application claims the benefit of U.S. Provisional Application No. 61/543,489 (filed Oct. 5, 2011), which is hereby incorporated by reference.

### BACKGROUND

The present invention is generally directed to seat covers for seats in boats and other vehicles. Certain aspects of the invention are directed in particular to fitted seat covers with a seating layer comprising a soft material such as chenille microfiber.

Seats for boats and other vehicles, particularly open-air vehicles in which the seats are designed to be exposed to the elements, often include seating surfaces constructed from a smooth plastic such as vinyl. Smooth plastic seating surfaces provide good durability and weather resistance. However, because the seats are often exposed to direct sunlight, the seating surfaces have a tendency to become very hot. Hot plastic seating surfaces may be uncomfortable or dangerous for passengers. This can be a particular problem for recreational boat seats since shade is often unavailable and passengers frequently wear swimwear which leaves large areas of skin exposed. Temporary solutions, such as laying a towel over the seating surface, are not optimal because the towel can easily shift out of position. Additionally, the material comprising towels and other prior art solutions is often not thick enough to provide optimal comfort to passengers

### SUMMARY

Problems with prior art seats and seat covers are solved by providing a seat cover which is generally fitted to a particular vehicle seat. The seat cover preferably comprises an attaching aid, such as elastic or a drawstring, which secures the seat cover to the seat. The seat cover also comprises a material that will be comfortable for seating, even in warm weather and direct sunlight, but which will dry quickly if dampened. In a preferred embodiment, the seating surface comprises a material which is also useful for cleaning the vehicle, such as chenille microfiber. In one embodiment, the seat cover is configured to be usable as a bag when not attached to a seat.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 is a perspective view of one embodiment of a seat cover.

FIG. 2 is a bottom view of the seat cover of FIG. 1.

FIG. 3 is a perspective view of an alternative embodiment of a seat cover.

FIG. 4 is a bottom view of the seat cover of FIG. 3.

FIG. 5 is a perspective view of another embodiment of a seat cover.

FIG. 6 is a bottom view of the seat cover of FIG. 5.

FIGS. 7A and 7B are a cross-section view of a seat cover and seat cushion.

FIG. 8 is a perspective view of a seat cover being used as a bag.

FIG. 9 is a view of seat covers in a boat.

### DETAILED DESCRIPTION

The numerous innovative teachings of the present application will be described with particular reference to presently preferred embodiments (by way of example, and not of limitation). The present application describes several inventions, and none of the statements below should be taken as limiting the claims generally.

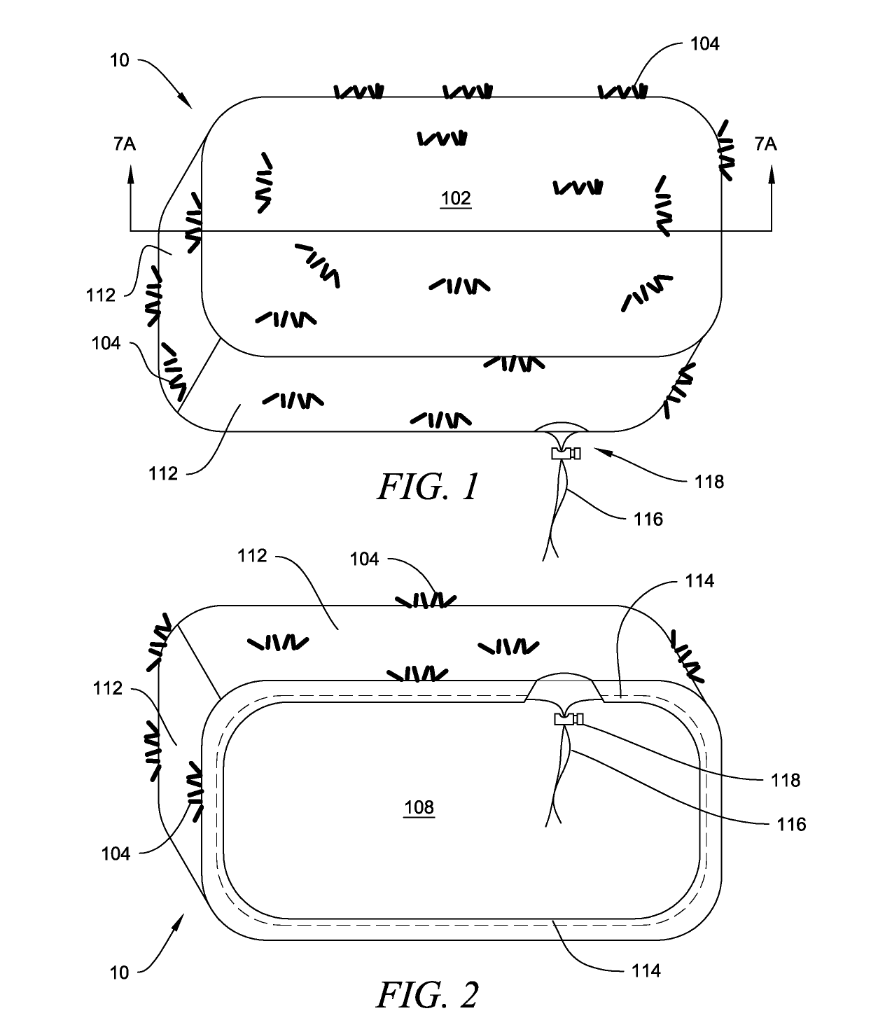

FIGS. 1 and 2 illustrate top and bottom views of a seat cover 10 embodying features of the present invention. Seat cover 10 comprises seat panel 102, which preferably comprises a sheet of flexible material cut in the general shape of the seat cushion that seat cover 10 is intended to cover. Seat panel 102 preferably comprises a material that is strong, yet flexible, and with structural properties will not change when exposed to moisture. Seat panel 102 may comprise vinyl, canvas, burlap, polyester, nylon, or the like.

Seat cover 10 preferably further comprises a seat comfort material 104 attached to seat panel 102. Seat comfort material 104 is preferably a material that will provide a layer of insulation and padding between a user (not shown) and a seat cushion 108. Preferably, seat comfort material 104 is (1) water absorbent; (2) able to dry quickly; (3) mildew resistant; (4) soft; (5) washable; and (6) useful for cleaning a vehicle.

Most preferably, seat comfort material 104 comprises chenille microfiber. Chenille microfiber is often sold as a fabric comprising a plurality of short tufts (typically 1 to 4 cm long) sewn or glued to a backing, in which case seat panel 102 would comprise the backing and seat comfort material 104 would comprise the tufts. The tufts are generally made from polyester and/or polyamide. Each tuft is covered by very fine fibers. Chenille microfiber is advantageous because it provides significant cushioning to the user and does not typically become uncomfortably hot to sit on. Further, Chenille microfiber is particularly useful for allowing the seat cover 10 to be used for washing a vehicle. That is, when seat cover 10 is not attached to a vehicle seat, seat cover 10 may be used to wipe or scrub a vehicle surface during washing. The microfibers are effective at removing dirt from surfaces being washed, yet the chenille microfiber itself may be cleaned by washing, e.g., in a washing machine. Chenille microfiber can also be used to dry persons or objects.

Alternatively, seat comfort material 104 can comprise terrycloth, foam, batting, wool, or the like.

Seat cover 10 is preferably attached to seat cushion 108 by skirt 112. Skirt 112 is attached to an outer perimeter of seat panel 102 and extends downwardly from seat panel 102. Skirt 112 preferably comprises the same material as seating panel 102. Alternatively, skirt 112 may comprise other materials, such as a mesh. Additionally, rather than being attached to seat cover 10, skirt 112 and may be formed as a single integral part with seat panel 102—that is, seat panel 102 and skirt 112 may comprise a single piece of material. Further alternatively, skirt 112 can comprise an elastic material, in which case channel 114 and engagement actuator 116 may be unnecessary.

A bottom edge of skirt 112 preferably comprises a channel 114 configured to hold an engagement actuator 116. Channel 114 is preferably formed by folding a portion of skirt 112. Engagement actuator 116 is used to tighten skirt 112 to seat cushion 108. Preferably, engagement actuator 116 comprises a drawstring. Engagement actuator 116 can be held in a tightened position by a clasp 118 or similar device. Alternatively engagement actuator 116, can comprise an elastic band, clip, strap, hook and loop fastener, or the like.

Seat cover 10 can also be made reversible. In a reversible embodiment, seat comfort material 104 is applied to both sides (inside and outside) of seat panel 102. Different textures or colors can be used for seat comfort material 104 on each side of seat panel 102 and a user can select which side will show when placing seat cover 10 on a seat.

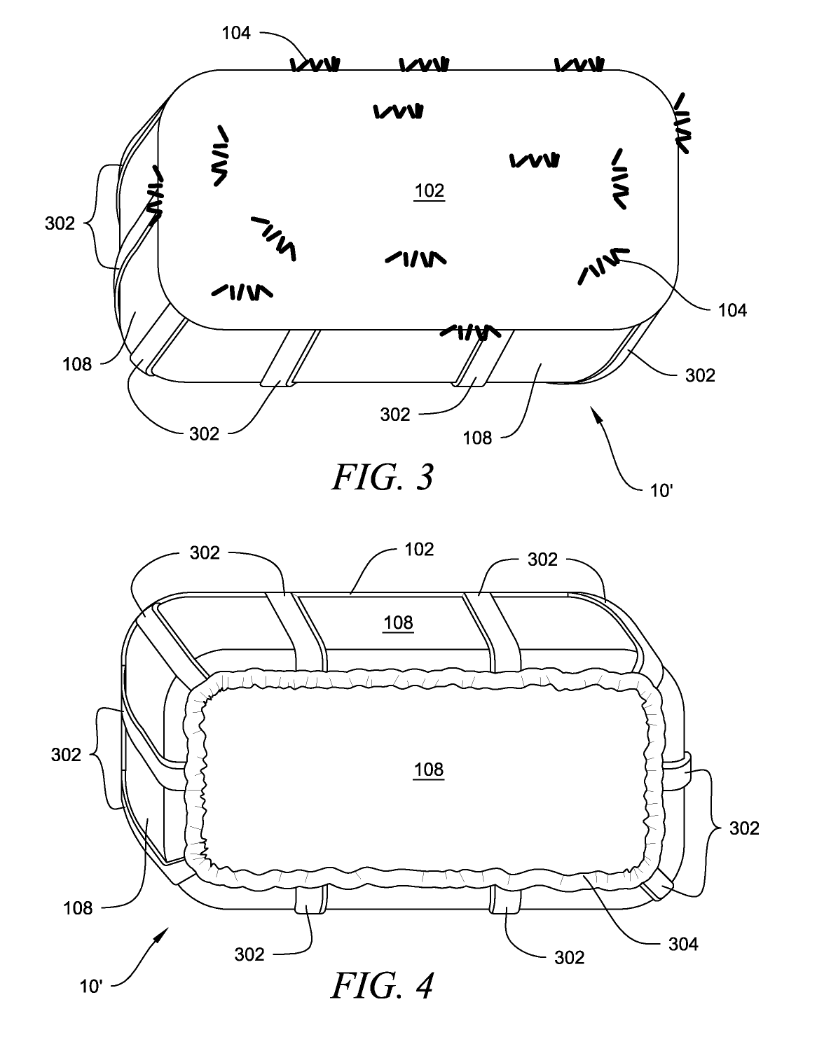

FIGS. 3 and 4 illustrates an alternative embodiment in which seat cover 10′ is attached to cushion 108 using connecting strips 302, which are attached at one end to seating panel 102 and at an opposite end to elastic band 304 (alternatively, a drawstring). Connecting strips preferably comprise the same material as seat panel 102. Alternatively to the embodiment of FIG. 3, seat cover 10 may be attached to cushion 108 using a combination of features similar to skirt 112 and/or connecting strips 302.

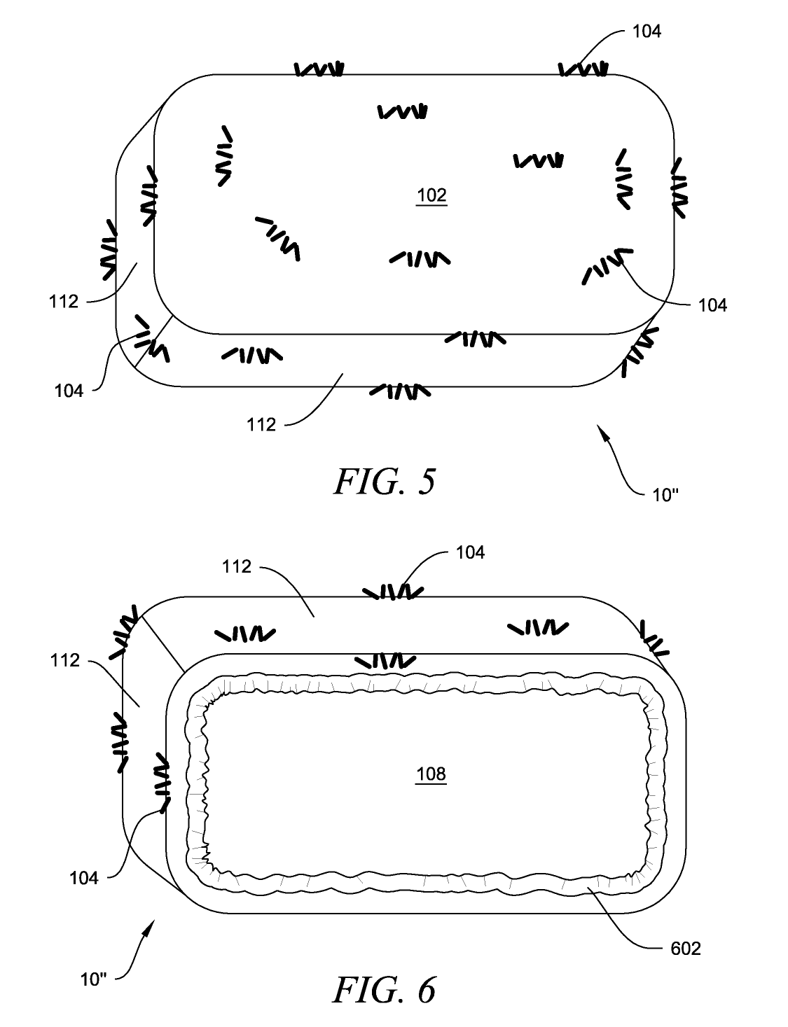

FIGS. 5 and 6 illustrate an additional alternative embodiment for a seat cover. Seat cover 10″ is similar in construction to seat cover 10 of FIGS. 1 and 2, but is secured to cushion 108 by elastic 602 attached to skirt 112.

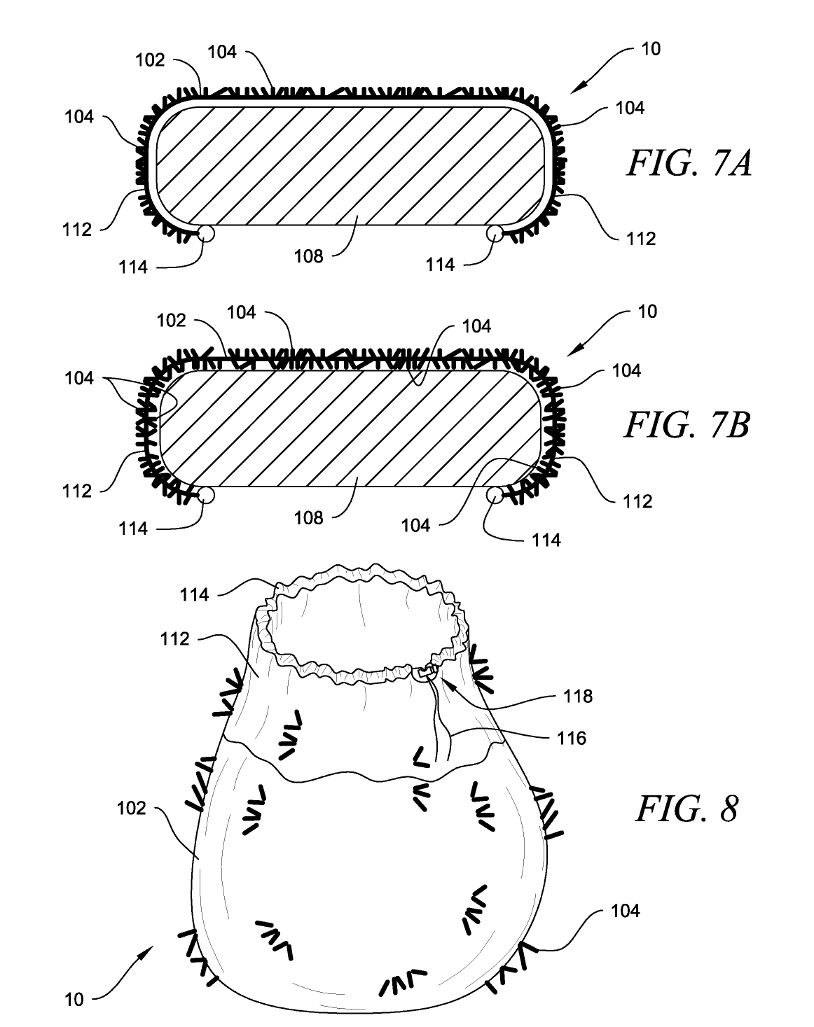

FIG. 7A shows a cross-section view of seat cover 10 and seat cushion 108. FIG. 7A better illustrates the configuration of seat comfort material 104. Seat comfort material 104 is shown covering the outer surfaces of seat panel 102 and skirt 112. This arrangement provides good user comfort and visual aesthetics. FIG. 7B illustrates an alternative embodiment wherein seat cover 10 is reversible and seat comfort material 104 also preferably covers inside surfaces of seat panel 102 and skirt 112.

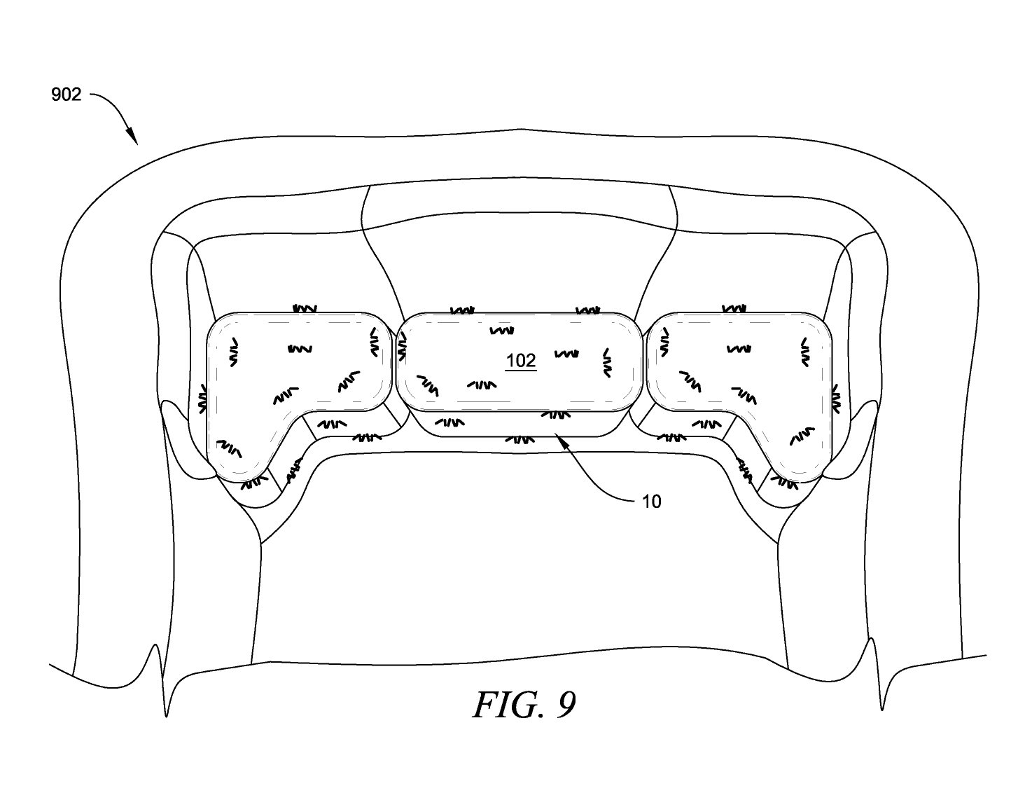

As shown in FIG. 8, seat cover 10, can be configured so that it forms a bag, when inverted and disconnected from cushion 108. In this arrangement, seat cover 10 can hold contents placed within it. Skirt 112 is preferably configured so that drawstring 116 may be used to substantially close seat cover 10 as a bag.

FIG. 9 illustrates seat covers 10 installed in a boat 902. Boat 902 is shown as a recreational motor boat, however, aspects of the described inventions could be used with many other types of vehicles. Although FIG. 9 only illustrates seat covers on seat bottoms, seat covers can likewise cover seat backs and other surfaces.

Although the invention has been described with reference to specific embodiments, this description is not meant to be construed in a limiting sense. Various modifications of the disclosed embodiments, as well as alternative embodiments of the inventions, will be apparent to persons skilled in the art upon reference to the description of the invention. It is, therefore, contemplated that the appended claims will cover such modifications that fall within the scope of the invention.

What is claimed is:

1. A boat seat cover comprising:
a seat surface generally corresponding to the shape of at least one surface of a boat seat cushion, wherein said seat surface comprises a user comfort material configured to thermally insulate a user from at least a portion of said boat seat cushion;
a skirt with a first edge and a second edge; wherein the first edge is attached to the seat surface;
an engagement actuator attached to the second edge of the skirt; wherein the engagement actuator is configured to secure the seat surface to the boat seat cushion by tightening said skirt under or around said boat seat cushion.

2. The boat seat cover of claim 1 wherein the user comfort material comprises chenille microfiber.

3. The boat seat cover of claim 1 wherein the user comfort material comprises terrycloth.

4. The boat seat cover of claim 1 wherein the engagement actuator is a drawstring.

5. The boat seat cover of claim 3 wherein the skirt and seat surface are configured to form a bag when the boat seat cover is not on a boat seat cushion and the drawstring and the second edge are configured to substantially close the bag when the drawstring is tightened.

6. A seat cushion cover comprising:
a seat panel with a shape conforming to at least one surface of a seat cushion, the seat panel comprising a flexible substrate which will not be harmed by exposure to moisture; and a chenille microfiber material affixed to the flexible substrate, the chenille microfiber material configured to insulate a user from a seat cushion; and
a seat attachment member configured to secure the seat cushion cover in a substantially stationary position when attached to a seat cushion.

7. The seat cushion covering of claim 6 wherein the seat attachment member comprises a skirt attached to the seat panel and configured to engage said seat cushion.

8. A seat cover comprising:
a seating surface;
one or more seat engagement members;
a drawstring attached to the one or more seat engagement members and configured so that the drawstring is capable of closing the seat engagement member and seating surface as a container.

9. The seat cover of claim 8 wherein said one or more seat engagement members comprise a skirt attached to said seating surface.

10. The seat cover of claim 8 wherein said one or more seat engagement members comprise a plurality of strips, wherein each of said plurality of strips is attached to said seat panel at a first end and engage a drawstring or elastic band at a second end.
